(19) United States
(12) Patent Application Publication
(10) Pub. No.: US 2017/0225204 A1
(43) Pub. Date: Aug. 10, 2017

(54) CONCRETE WASHOUT APPARATUS

(71) Applicant: Jesse Silkwood, Chapin, SC (US)

(72) Inventor: Jesse Silkwood, Chapin, SC (US)

(21) Appl. No.: 15/017,005

(22) Filed: Feb. 5, 2016

(51) Int. Cl. B08B 3/04; B08B 17/02

(52) U.S. Cl. CPC B08B 3/04; B08B 17/025

(57) ABSTRACT

A portable, reusable concrete washout is provided. In a preferred embodiment, the washout is constructed from a series of blocks that can be removably interlocked together and can be easily transported so that the washout may be assembled and disassembled onsite. A plastic sheet or other containment member can be laid over and secured to the washout to hold and contain the mixture of water and concrete as it is washed from the equipment. The blocks are preferably poly-cuboidal in shape and design, whereby the blocks can be stacked and overlap with one another. The blocks further include at least one type of interlocking mechanism for the removable interlocking and attachment of one block to another.

### BACKGROUND OF THE INVENTION

Concrete is used extensively in the construction industry and is typically carried to job sites in transit mixer trucks, or on site mixers, and may be moved at a work site to a point-of-use by concrete pump trucks. When pumping or pouring is complete, a small amount of concrete may remain in the truck, while concrete residues remain on portions of both vehicle mounted and manually operated equipment. Failure to quickly remove the concrete residues allows the concrete to harden thereby complicating the cleanup process and in some cases damaging the equipment. The mixer and pump portions of the truck along with concrete finishing tools must be washed off at the job site after pouring or pumping concrete to allow continued use of the equipment.

At present, concrete residue removal and cleanup is typically accomplished at a temporary disposal location, generally comprising a pit dug in the ground which may in some cases be covered with plastic sheet and surrounded by hay bails. Alternatively, hay bails may be stacked to form a four sided barrier over which a plastic sheet is placed and secured. On a concrete pump truck, a plug is removed from the bottom of the concrete pump which allows waste concrete to drain into the disposal pit. The concrete carrier portions are then washed, such as with a hose, to remove concrete residues. A similar operation is performed for transit mixer trucks, and other equipment for handling concrete.

Concrete itself, once hardened, is inert and harmless to the environment. However, the water used to cure concrete, or to clean equipment used to deliver and place concrete, can raise the pH level of surrounding waters and increase the heavy metal content, either of which can in some cases harm living organisms. Therefore, primarily due to environmental concerns and requirements, the concrete is commonly drained into a pit covered with a waterproof sheet, such as a plastic sheet. When the waste concrete materials harden, they are typically removed from the pit and transported to a permanent disposal site. The difficulty with such an approach is that it requires digging a pit, lining the pit, waiting for the waste concrete material to dry, and loading and transporting the dry waste concrete material to another site. In some cases a number of pits need to be dug, during a construction project increasing the impact to the environment. Furthermore, spills can occur while dumping the wet concrete into the pit and washing out the residues, while the sheet material is subject to punctures and tearing, any of which can impact the environment. Consequently, the washing out of concrete equipment must be performed with careful regard for containing runoff from construction sites.

As populations have grown and construction has crowded into new areas, building sites are increasingly being considered as possible threats to the environment. Environmental awareness is increasing and construction sites in many areas are required to follow “Best Management Practices” (BMPs) with regard to waste disposal practices, such as adhering to “Storm Water Pollution Prevention Plans” (SWPPP). Most states now impose strict, complex environmental regulations for operators at construction sites for the containment and removal of concrete, cement, mortar and/or paint washout runoffs. These regulations are cumbersome and complicated, including rules regarding container structure specifications, allowable placement of such containers on site, and even materials to be used for such containers. A violation of these local rules can result in the imposition of expensive fines and possible quasi-criminal penalties.

Several U.S. Patents and Publications describe concrete washouts, and are incorporated herein by reference. For example, U.S. Pat. No. 7,121,288 describes a washout container to which are mounted inclined ramps that allow a transit mixer, concrete pumping truck or other concrete handling vehicle to drive up over a portion of the container for dumping excess concrete and washing out waste concrete. A watertight latching door assembly is coupled to the container to prevent leakage of collected liquid concrete waste material while allowing solidified concrete materials to be unloaded at a disposal site. The interior of the container is preferably lined with a material to which concrete will not adhere. The liner may be applied as a coating to the interior of the container or as a solid material retained within the container. In this way, solidified waste concrete can be easily removed from the container at the disposal site and preferably crushed for recycling.

U.S. Pat. No. 7,913,704 describes a system for washing-out concrete pouring equipment includes a bin for receiving waste materials washed with water from the concrete pouring equipment. The bin includes openings allowing liquid to drain into a base unit that includes sidewalls defining a receptacle for receiving the bin and a sloped bottom for conveying liquid drained from the bin to a sump. A filtering system filters particulate matter from liquid provided from the sump to recover the water.

U.S. Pat. No. 8,177,087 describes a concrete washout bag system that includes a frame and a foldable washout bag which is assembled onto the frame by means of unitarily formed sleeves, and is manufactured from a strong, water-proof material that allows it to be hoisted for carrying away heavy loads without tearing and includes a drawstring closure for retaining of washout materials during the hoisting, removal process.

In view of the current state of the art, a need exists for an apparatus for facilitating concrete disposal that allows convenient emptying and cleaning of waste concrete from concrete mixing, hauling, and/or concrete application equipment without subjecting the environment to contamination hazards. It would be advantageous to provide a portable, reusable concrete washout that satisfies those needs, as well as others, and overcomes the deficiencies of previously developed concrete disposal solutions.

### BRIEF SUMMARY OF THE INVENTION

The present invention relates to a portable, reusable concrete washout constructed from a series of blocks that can be removably interlocked together to form an assembled washout. In a preferred embodiment, the blocks are constructed from a durable plastic material and can be easily transported so that the washout may be assembled and disassembled onsite. A plastic sheet or other containment member can be laid over and secured to the washout to hold and contain the mixture of water and concrete as it is washed from the equipment. Typically, hay bails are stacked together to form a concrete washout; and, it is contemplated that the blocks of the present invention may replace conventional hay bails, thus providing a reusable, cost-efficient solution to the concrete washouts of the current art.

The blocks may be poly-cuboidal in shape and design, generally having an “S” or “Z” shape, although other suitable shapes may be used as well. The overall shape and design of the blocks are such that the blocks may be flipped in different orientations and still used to construct a usable concrete washout. The blocks include an interlocking mechanism for the removable interlocking and attachment of one block to another and may further include a handle for lifting and transporting the blocks. The blocks preferably include holes for staking a plastic containment sheet at each corner of the assembled washout.

### DESCRIPTION OF THE DRAWINGS

These and other features, aspects, and advantages of the present invention will become better understood with regard to the following description, appended claims, and accompanying drawings where:

FIG. 1a illustrates a perspective view of one embodiment of a block used to assemble a concrete washout of the present invention;

FIG. 1b illustrates a perspective view of an alternative embodiment of a block used to assemble a concrete washout of the present invention, this block showing additional holes for insertion of a rod to interlock multiple blocks to one another;

FIG. 2a is a top view of the block shown in FIG. 1a;

FIG. 2b is a top view of the block shown in FIG. 1b;

FIG. 3a is a side view of one embodiment of a block used to assemble a concrete washout of the present invention;

FIG. 3b is a front view of one embodiment of a block used to assemble a concrete washout of the present invention;

FIG. 4a is a top view of one embodiment of a concrete washout of the present invention assembled from the blocks shown in FIG. 1a;

FIG. 4b is a top view of one embodiment of a concrete washout of the present invention assembled from the blocks shown in FIG. 1b, showing additional holes for insertion of rods to interlock multiple blocks to one another during assembly;

FIG. 4c is a top view of one embodiment of a concrete washout of the present invention assembled from blocks that include a four-hole pattern for insertion of rods to interlock multiple blocks to one another during assembly;

FIG. 5 is a side view of one embodiment of an assembled concrete washout of the present invention;

FIG. 6 a top view of one embodiment of a concrete washout of the present invention further including a divider member for dividing the concrete washout into smaller sections; and

FIG. 7 is an exploded view of the assembly of one embodiment of a concrete washout of the present invention.

### DETAILED DESCRIPTION OF THE INVENTION

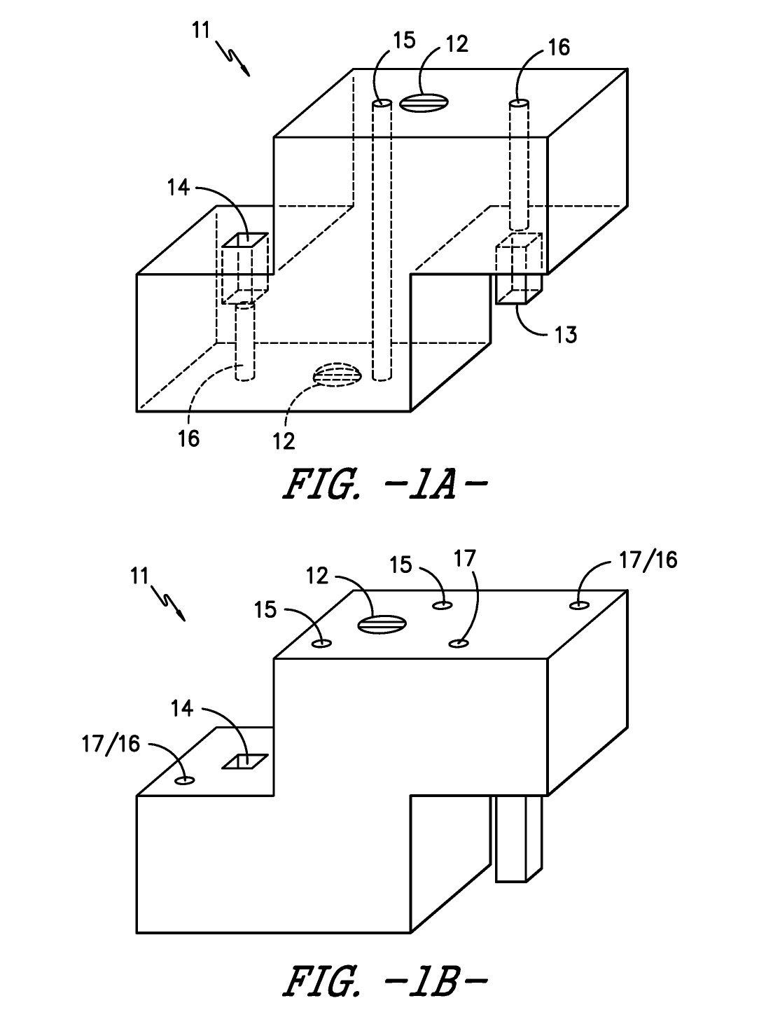

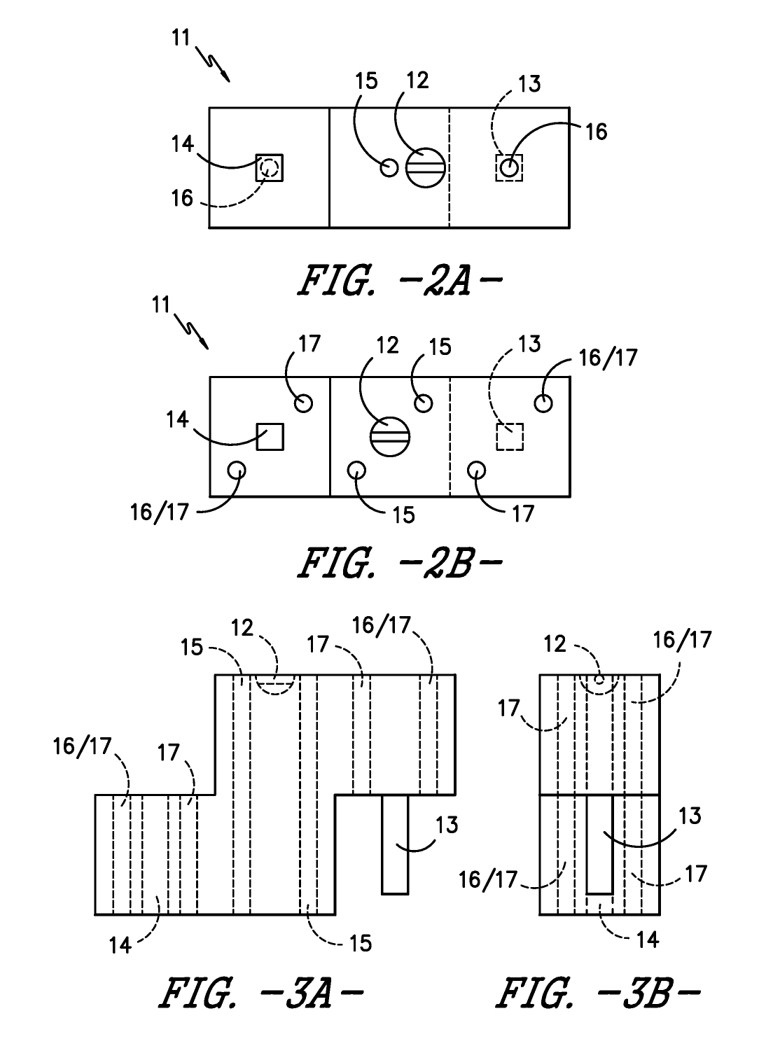

A concrete washout system 10 of the present invention is designed to include a plurality of blocks 11 interlocked and assembled together to form a reusable concrete washout 10. The blocks 11, shown FIGS. 1a and 1b, are preferably constructed from a durable plastic material through injection molding; although it is to be understood that any other suitable material and method may be used. The blocks 11 can be easily transported such that the washout 10 may be assembled and disassembled onsite. The blocks 11 are preferably designed to removably attach to one another in an overlapping fashion. A plastic sheet or other containment member 20 can be laid over and secured to the washout 10 to hold and contain the mixture of water and concrete as it is washed from the equipment.

The blocks 11 used to construct the washout 10 of the present invention preferably comprise at least one type of interlocking mechanism 13, 14, 17, 18 such that the blocks 11 can be removably fitted together in any desired size and arrangement. In a preferred embodiment, the blocks 11 may be poly-cuboidal in shape and design such that the blocks 11 overlap, stack, and interlock together like a simple puzzle. A polycube is a geometric figure formed by joining one or more equal cubes face to face. In one embodiment, the block 11 may be an N-tetracube resembling skew tetromino—meaning it has a generally “S” or “Z” shape. It is also contemplated that the blocks 11 may resemble a T-tetracube. The preferable dimensions for each block 11 are approximately 3 feet long by 1-1.5 feet wide by 2-2.5 feet high, although any suitable dimension may be used.

Referring now to FIGS. 1a and 1b, a first embodiment of this invention is represented by an S-shaped N-tetracube 11. The top surface of the upper portion of the “S” may include a concave inset for a handle 12 used to lift and transport the blocks 11. A similar inset handle 12 may be included on the bottom surface of the lower portion of the “S”, or underside of the block 11, so that the block may be flipped over and used in both the “S” and “Z” formation. By insetting the handle 12, the block 11 can sit flat on the ground without, the handle 12 interfering with the leveling of the washout 10.

Each block 11 includes an interlocking mechanism 13, 14, 17, 18 for removably attaching or fixing the blocks 11 to one another. The positioning and arrangement of the interlocking mechanism 13, 14, 17, 18 is preferably such that the blocks 11 may be interlocked together in at least both a straight row and at right angles to form both walls and corners. It is also contemplated that an type of interlocking mechanism can be used such that the blocks 11 may be interlocked together at various angles, in addition to a 90 degree angle, to accommodate the assembly of the concrete washout 10 on a site where space may be limited or otherwise awkward, for example in a busy urban setting. These unconventional angles may be achieved by using an attachment mechanism that allows one block 11 to more or less freely rotate upon another block 11 while attached. For example, a hole 17 may be provided on an upper portion of one block 11 that corresponds with a hole 17 on a lower portion of an adjacent block 11, such that when the blocks 11 are stacked, the holes 17 align. A rod 18 may be inserted through the holes 17, thus allowing one block 11 to rotate with relation to the other while the blocks 11 remain held together through the use of the rod 18.

FIGS. 1a and 1b illustrate an example of a removable interlocking mechanism 13, 14 that may be used in the present invention. FIGS. 1a and 1b show a male 13 and female 14 interlocking member comprising a male member 13 protruding from the lower surface of the upper portion of the “S” and corresponding female receiving member 14 located in the upper surface of the lower portion of the “S”. When the blocks 11 are assembled to form a washout 10, the upper and lower portions of the “S” overlap and fit together such that the male member 13 inserts into the female member 14, removably connecting the blocks 11 together. In this particular example, the male 13 and female 14 member are squared-off; however, the members could be any suitable shape provided they correspond with one another. The male/female members 13, 14 may be rounded-off to allow one block 11 to rotate with relation to another, as described previously above; or the male/female 13, 14 members may be squared-off to facilitate maintaining the blocks 11 in a straight row and eliminate deviation from a desired arrangement.

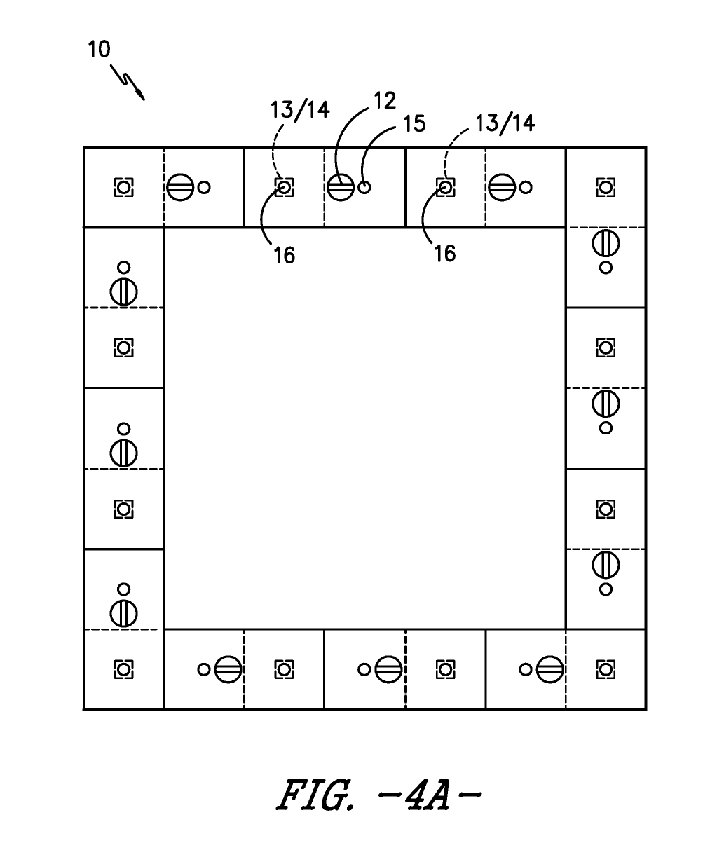

In a preferred embodiment, the blocks 11 of the present invention include at least one hole 15 that passes through the length of the central portion of the block 11, from top to bottom, illustrated best in FIGS. 1a and 3. A wooden or metal rod, dowel, or any other support member 18 may be inserted into this hole 15 to provide structural reinforcement of the block 11. Since the blocks 11 are preferably made of a plastic material, by inserting at least one solid, removable support member 18, the plastic can be structurally reinforced if necessary. At least one other hole 16 may be included in the upper portion of the “S” and the lower portion of the “S”, as shown in FIG. 1a. A T-post or stake 19 can be inserted into one of these holes 16 at each corner of the assembled washout to stake the plastic containment sheet or containment member 20 in place. It is to be noted that the hole 16 for a stake 19 is preferably located on the top surface of upper “5” portion and the bottom surface of the lower “S” portion, such that regardless of the orientation of the block 11 (flipped “right-side up” to form an “5” or “upside down” to form a “Z”) a hole 16 is accessible for staking the block 11.

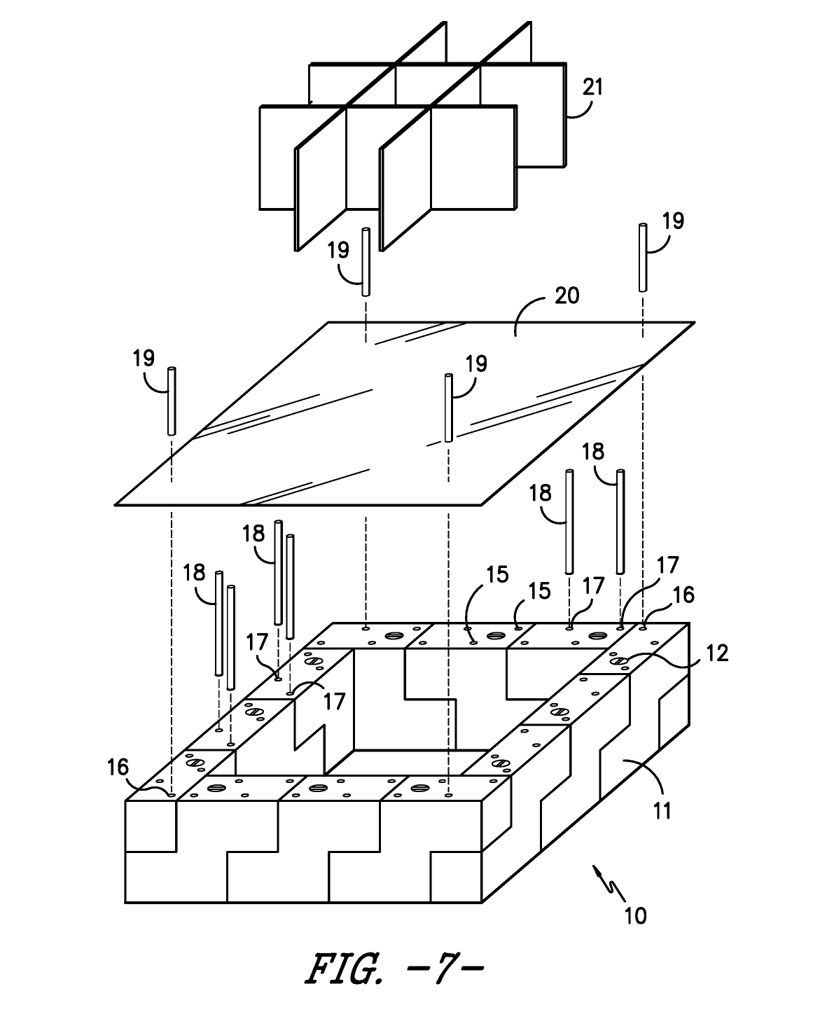

FIGS. 1b, 3a and 3b illustrate another example of an interlocking mechanism that may be used on the blocks 11 of the present invention. At least one hole 17 may be channeled through the upper portion of the “S” corresponding in position to a hole 17 channeled through the lower portion of the “S”, such that when the blocks 11 are stacked and overlapping, the holes 17 align and a removable rod 18 may be inserted through the length of the corresponding holes 17 thus securing the blocks 11 together and in place. This arrangement is best illustrated in FIG. 7, which shows the blocks 11 stacked and interlocked into place through the use of rods 18.

Although this description describes the above interlocking mechanisms in detail, other removable interlocking mechanisms may be used such as tongue and groove, snap fit, and other male/female interlocking members.

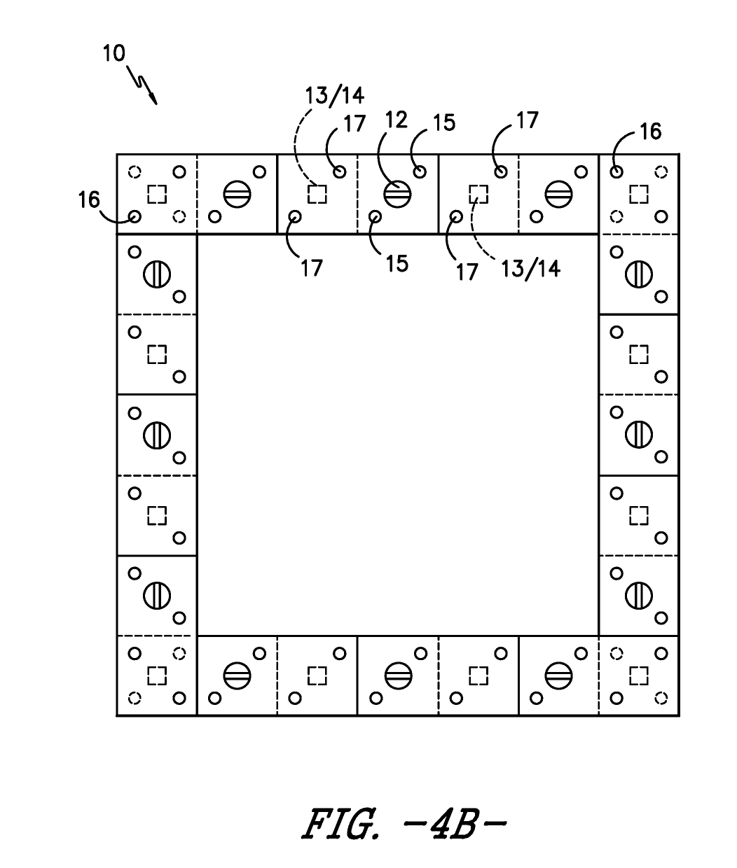

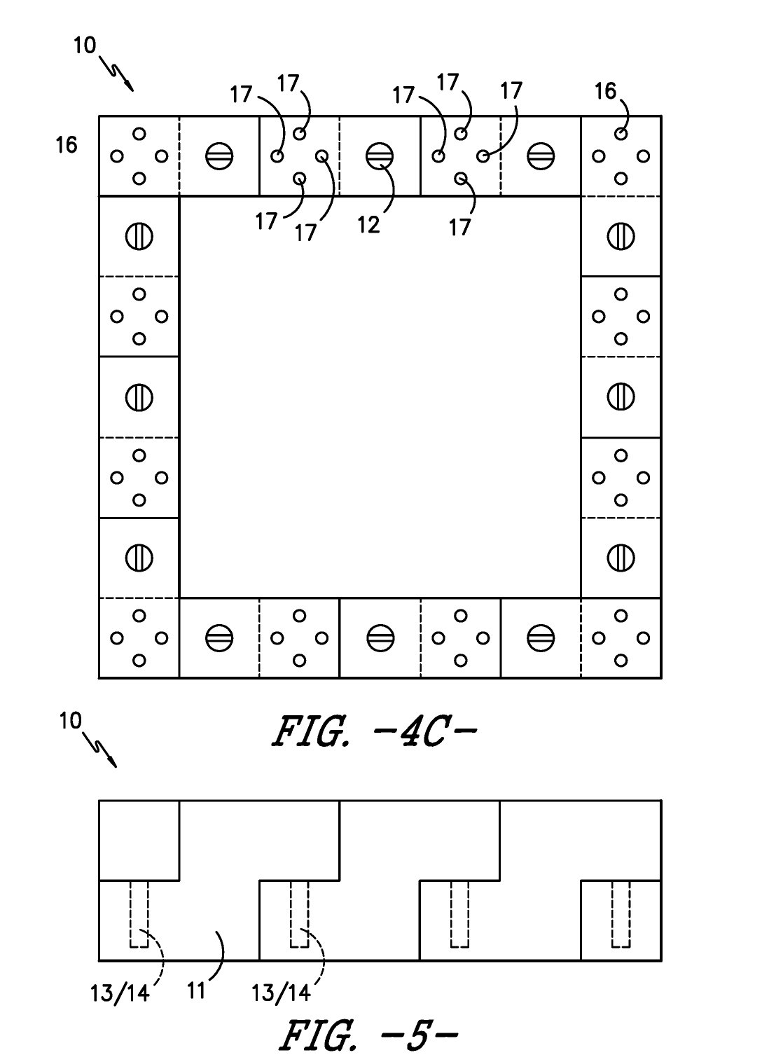

FIGS. 4a, 4b, and 4c show embodiments of an assembled concrete washout 10 of the present invention. It is contemplated that the blocks 11 may be assembled together whereby an upper portion of one tetracube 11 is stacked on a lower portion of another tetracube 11, such that the blocks 11 overlap at one or more sections and can be removably secured together. For example, FIG. 5 shows an upper portion of a first block 11 overlapping and interlocking with a lower portion of a second block 11, the second block 11 having an upper portion overlapping and interlocking with a lower portion of a third block 11, so on. FIGS. 4a, 4b, and 4c illustrate an embodiment whereby the assembled washout 10 is square shaped with preferably three blocks 11 per side. At each corner, the upper portion of one block 11 overlaps and interlocks with the lower portion of another block 11 at a 90 degree angle. The size of the washout 10 can be adjusted by increasing or decreasing the number of blocks 11 used to construct each side of the washout 10.

Once the blocks 11 are secured together, a containment member 20 may be dropped over and inside the washout 10. The containment member 10 can be a plastic sheet that is placed over and inside the washout 10 and further secured by staking the plastic sheet 20 into a hole 16 located on the blocks 11 at each corner of the washout 10, as shown in FIG. 7. An alternative containment member 20 may be a disposable plastic or metal tub that is dimensioned to be dropped inside the assembled washout 10. Once the concrete is washed out of the mixer and equipment, the washed concrete may be poured into the containment member 20 or plastic sheet to dry and harden. Once hardened, the concrete can be broken up into smaller pieces for removal and disposal. Once the concrete is removed, the containment member 20 can be disposed of and the washout 10 may be disassembled by detaching the blocks 11 from one another. The washout 10 may be taken apart in single blocks 11 or in sections; the handles 12 allow for the blocks 11 or sections of blocks to be picked up and carried away.

It is contemplated that the blocks 11 can be assembled into cubes or rectangular cuboids for easy, symmetrical packing in the back of a pickup truck or other vehicle. For example, the blocks 11 can be assembled together in groups of four to form a semi-solid cube-like shape that can be packed together for transportation. Alternatively, the blocks 11 can be assembled together in groups of six to form a semi-solid rectangular cuboid with space in the middle to fit a seventh block. In this way, rather than randomly packing the blocks 11 loosely for transportation from one construction site to another, the blocks 11 can be compacted together to save space.

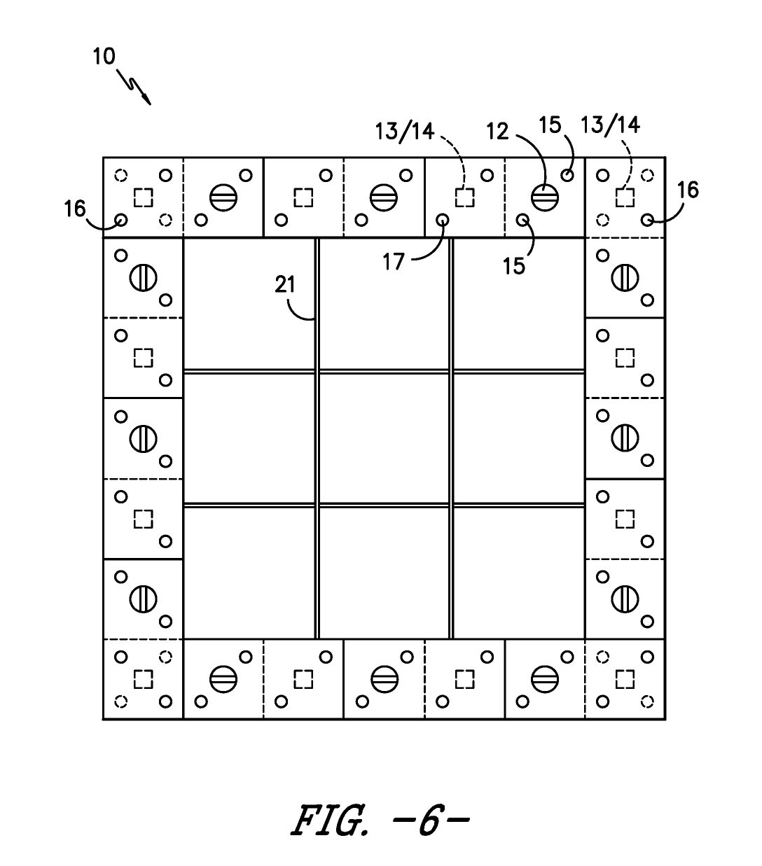

The concrete washout 10 of the present invention may also include slats that form dividers 21 dividing the washout 10 preferably into nine smaller sections, as shown in FIGS. 4c and 6. In this way, the hardened concrete can be more easily removed in smaller sections without the need to break up one large piece of concrete onsite. If the containment member 10 is a pre-formed tub that fits into the assembled washout 10, it is contemplated that the tub may be designed to include these dividers 21. These dividers 21 are preferably made of a durable plastic or metal that can withstand the weight and pressure of the concrete without buckling, breaking or collapsing during use.

FIG. 7 is an exploded view illustrating an exemplary assembly of the present invention. A perspective view of one embodiment of an assembled washout 10 is provided, showing the manner in which rods 18 may be inserted into holes 15, 16, 17 present on the blocks 11 for both securing the blocks together and for staking the containment member 20 to the washout 10. First, the washout 10 may be assembled by stacking and interlocking the blocks 11 together. In this figure, rods 18 are shown inserted into corresponding holes 17 for interlocking the blocks 11 together. After the containment member 20, or plastic sheet, is placed over and into the washout 10, the containment member 20 maybe secured into the washout 10 by inserting a stake 19 through the corners of the containment member 20 and into stake holes 16 that may be located at the each corner of the washout. Next, an optional dividing member 21 may be inserted to create smaller blocks of concrete during the washout process.

What is claimed is:

1. An apparatus for collecting a volume of concrete washout material comprising:
a portable, reusable container having a plurality of assembled walls, said walls constructed from a plurality of blocks removably connected to one another, each of said blocks comprising at least one interlocking mechanism for removably interlocking one block to another block in series; and
a containment member for insertion into said container formed by said assembled walls for containing concrete washout material for hardening.

2. The apparatus of claim 1, further including a divider member dimensioned to fit flush inside said container whereby said divider member provides separate receptacles for said concrete washout material so that said material may be poured to harden in separate sections.

3. The apparatus of claim 1, wherein said interlocking mechanism comprises a male member and a female receiving member.

4. The apparatus of claim 1, wherein said interlocking mechanism comprises at least two corresponding holes extending vertically through a portion of each block, whereby at least one hole of one block may be aligned with at least one hole of another block so that the aligned holes may receive a single rod member for connecting one block to another block.

5. The apparatus of claim 1, wherein each wall further includes a hole on a top surface of said wall whereby a stake may be inserted into said hole for securing said containment member to said wall.

6. The apparatus of claim 1, whereby said blocks are polycubes.

7. The apparatus of claim 6, whereby said polycubes are N-tetracubes.

8. The apparatus of claim 7, whereby each of said N-tetracubes comprises a male attachment member on a first portion of said N-tetracube and a corresponding female receiving member on a second portion of said N-tetracube; and
whereby the male member of a first N-tetracube may be received by the female member of a second N-tetracube so that the first portion of a first N-tetracube may be connected to the second portion of a second N-tetracube.

8. The apparatus of claim 7, whereby each of said N-tetracubes further includes a hole extending vertically along a central vertical axis of said N-tetracube whereby a rod member may be inserted through said hole for structural support and reinforcement.

9. The apparatus of claim 1, wherein said blocks are constructed from plastic.

10. The apparatus of claim 1, wherein said block further includes a first inset handle positioned on a top surface of said block and a second inset handle positioned on a bottom surface of said block.

11. A block for constructing a concrete washout container, said block comprising:
at least one interlocking mechanism for removably connecting one said block to another said block;
at least one hole centrally located and extending vertically along a central vertical axis of said block for receiving a reinforcing rod member;
at least one bole on at least one outer facing surface of said block for receiving a stake; and
whereby a plurality of said blocks are capable of being connected in series to construct a plurality of walls.

12. The apparatus of claim 11, wherein said block is a polycube.

13. The apparatus of claim 12, wherein said polycube is an N-tetracube.

14. The apparatus of claim 13, whereby said N-tetracube comprises a male attachment member on a first portion of said N-tetracube and a corresponding female receiving member on a second portion of said N-tetracube; and
whereby the male member of a first N-tetracube may be received by the female member of a second N-tetracube so that the first portion of a first N-tetracube may be connected to the second portion of a second N-tetracube.

15. A method of cleaning concrete at a construction site comprising the steps of:
providing a portable, reusable container having a plurality of assembled walls, said walls constructed from a plurality of blocks removably connected to one another, each of said blocks comprising at least one interlocking mechanism for removably interlocking one block to another block in series;
providing a disposable containment member;
placing said containment member over and inside said container;
positioning a concrete chute, concrete utensils, or other concrete-contaminated objects above the washout container; and
removing concrete from the chute, utensils, or other objects with water such that the water and concrete enter the washout container.

16. The method of claim 15, further including the steps of:
providing a dividing member dimensioned to fit flush inside the washout container; and
inserting said dividing member into said container and on top of said containment member to divide said container into separate sections prior to the positioning step.

17. The method of claim 15, further including the steps of:
letting the concrete harden; and
disconnecting the blocks from one another to disassemble the container.
